(19) United States
(12) Patent Application Publication
(10) Pub. No.: US 2006/0071106 A1
(43) Pub. Date: Apr. 6, 2006

(54) Turbine driven fishing reel

(76) Inventor: John Thomas Hillstrom, Crystal, MN (US)

Correspondence Address: Paul H. Gallagher, 2439 Jackson Avenue, Evanston, IL, 60201, US

(21) Appl. No.: 10/956,883

(22) Filed: Oct. 4, 2004

(51) Int. Cl. A01K 89/01

(52) U.S. Cl. 242/224; 242/249; 242/323

(57) ABSTRACT

A turbine operated fishing reel unit is herein disclosed. The reel unit includes a reel for fishing line that is coupled to a turbine. A mechanism for coupling a source of compressed fluid to the turbine is also secured to the reel unit. Activation of a valve that is connected between the source of compressed fluid and the turbine permits compressed fluid to flow through turbine, thereby rotating the turbine and the reel that is coupled thereto.

### FIELD OF THE INVENTION

The invention resides in the field of fishing reels. It is intended for use by persons who are partially handicapped such as those having the use of only one hand.

### DISADVANTAGES OF PRIOR KNOWN FISHING REELS

In the case of prior known fishing reels, the user must mount the fishing rod on the boat to enable him to use his good hand for reeling in the line.

An object of the present invention is to overcome the foregoing disadvantage.

Another and more specific object is to provide a device which can be mounted on the usual fishing rod without in any way impairing the use of the fishing rod, and which is rendered active by use of a simple element such as a push button, or finger trigger.

### BRIEF DESCRIPTION OF INDIVIDUAL FIGURES OF THE DRAWINGS

FIG. 1 is a line-thickness sketch of a user holding a fishing rod with the device of the present invention applied thereto.

FIG. 2 is a semi-diagrammatic view of a fishing rod oriented according to FIG. 1 and showing the main components of the device.

FIG. 3 is a diagrammatic view from the top of FIG. 2.

FIG. 4 is a view, partially in section and partially in elevation, of the main part of the device and taken at line 3-3 of FIG. 2.

FIG. 5 is a fragmented view taken at line 5-5 of FIG. 4.

FIG. 6 is a sectional view taken at line 6-6 of FIG. 5.

FIG. 7 is a fractional view taken at line 7-7 of FIG. 6.

FIG. 8 is a view taken at line 8-8 of FIG. 7.

FIG. 9 is a semi-diagrammatic view taken at line 9-9 of FIG. 4.

FIG. 10 is a semi-diagrammatic view of a form similar to that of FIG. 9 but constituting a variant of FIG. 9.

FIG. 11 is a view similar to FIG. 10 but showing another variant of turbine.

FIG. 12 is a fractional view, partially in section, showing the mounting connection of a vane on the plate in a turbine.

### DETAILED DESCRIPTION OF THE DEVICE

FIG. 1 shows a fisherman 20 holding a fishing rod 22 and in accordance with the main intent of the invention, this figure shows a fisherman with one hand, at 24, by which he is holding the fishing rod.

The device of the invention is shown in its entirety at 26 FIG. 2 attached to the fishing rod 28. The fishing rod 28 may be of known type, determining a main longitudinal axis 31, and includes a main rod 30 having a handle portion 32.

The fishing rod has a series of eyelets 34 through which the fishing line 35 is threaded for holding the line on the rod. The extended end, or that end reaching away from the handle, is at the right of FIG. 2 and indicated at 36.

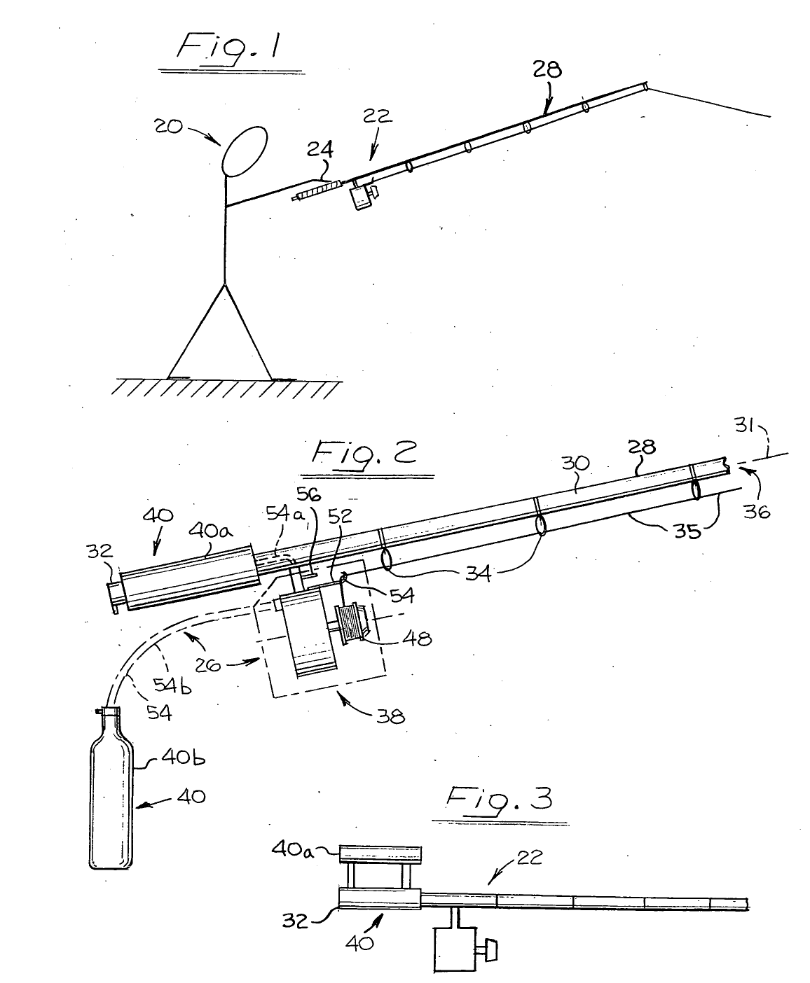

The device of the invention includes a main unit 38 and one or more air-pressure tanks 40, individually identified 40a and 40b which may be identical in construction. One of the units, 40a is mounted on the handle 32 of the rod 30 and preferably spaced laterally therefrom (FIG. 3).

The other unit, 40b, may constitute an optional air-pressure tank which may be mounted on the body of the user, or at other suitable location.

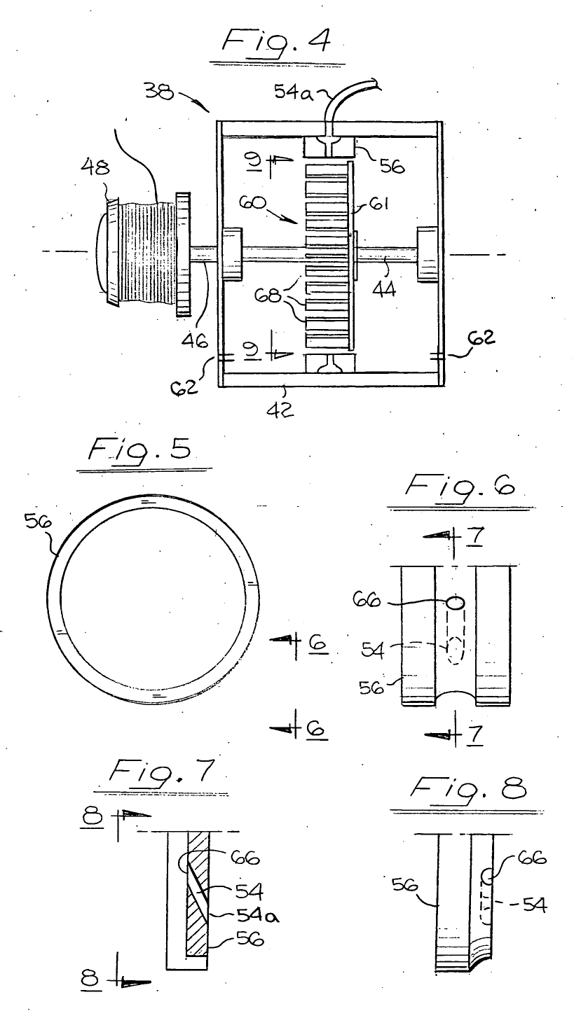

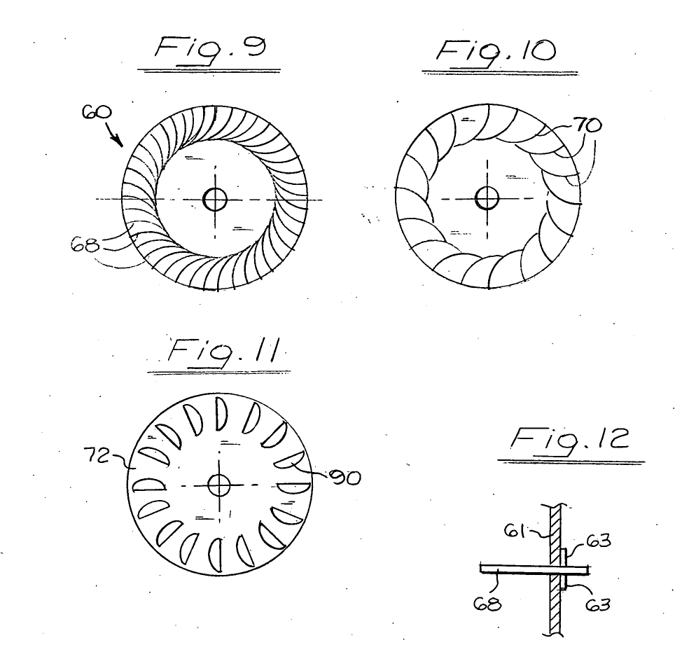

The unit 38 may be considered the actuating unit, including the main mechanically moving parts. The interior of this unit is shown in FIG. 4, and includes a housing or casing 42 preferably cylindrical, which includes a central, axial shaft 44 mounted therein, the latter having an extended end 46 on which a fishing line spool 48 is mounted at the exterior of the housing. The spool 48 may be of known kind, and upon its rotation, it draws in, or reels in, the fishing line.

Mounted on the shaft 44 is a turbine 60, to be described below, and upon rotation of the turbine, the reel is driven and winds up the fishing line as stated.

Mounted on the housing 42 is a finger 52, FIG. 2, having a hook 54 at its outer end, for guiding the fishing line 35 when mounting the device on the fishing rod.

As described hereinbelow, the compressed air is released from one of the tanks 40 and enters into the housing 42 and drives the turbine.

The air pressure tanks 40 are of known kind, having connections 54a for conveying the compressed air from the tanks into the housing 42 for driving the turbine 60. These connections will be referred to again hereinbelow.

The air tanks 40 are provided with on-off valves 56 respectively for connecting the air tanks with the housing 42.

Attention is directed to FIGS. 2 and 4 for showing of the passage for the compressed air to flow into the container. The passage 54a is shown in FIG. 4 entering into the wall of the container and into a ring 56 which is secured to the inner surface of the wall.

The inner end of the passage 54a is directed into the turbine 60 in tangential direction for driving it as seen in FIGS. 6-8.

The housing is arranged in correspondence with the inlet of the air, so that the air as it moves through the turbine emerges from the container through an outlet opening 62, at the opposite side of the turbine from the inlet, flowing to the exterior.

Thus it will be seen that a quantity of static fluid matter is converted into a fluid condition and utilized for rotating a reel for reeling in a fishing line.

Thus the important advantage is realized, that the fishing rod can be put through its funcions by a user who has only one hand.

The device may be made of any of various materials, and particularly may be made of plastic, or aluminum,

I claim:

1. A one-handed fishing reel for use on a conventional fishing pole, comprising,
a reel unit including a reel capable of having the fishing line operably connected thereto,
a turbine operably connected to the reel, and
means for detachably securing a supply of compressed air to the reel,
means for converting static fluid to fluent fluid for actuating the reel.

2. A fishing reel unit adapted for mounting on a conventional fishing pole having a rod forming a pole proper, and a line on the rod,
the rod having an inner end forming a handle, and an outer end, and the line being mounted on the rod at the inner end of the latter and extended to and beyond the outer end thereof,
the fishing reel unit including,
a housing,
a shaft rotatably mounted in the housing and having an end extended to the exterior of the housing,
a turbine in the housing and mounted on the shaft for turning the latter
a turbine turbine in the housing and mounted on the shaft for turning the latter,
a spool secured to the outer end of the shaft and thereby positioned exteriorly of the housing,
the inner end of the line being secured to the spool for winding up on the spool, and
a container for holding compressed air, and means for mounting the housing on the rod.

3. A fishing reel unit according to claim 2 and including means for detachably mounting the unit on the rod.

4. A fishing reel unit according to claim 2 and including, means for detachably securing the air tank on the handle, and means for conducting compressed air from the air tank to the housing in operative relation to the turbine.

5. A fishing reel unit according to claim 4 and wherein, the housing has a second inlet opening, and the unit includes means for conducting air from a second air tank to said second inlet opening in the opening.

6. A fishing reel unit according to claim 1 and wherein, the housing is substantially cylindrical, and it has an inlet passage formed to produce an outlet inner end with a portion directed tangentially to the turbine.

7. A fishing reel unit according to claim 5 wherein, the housing includes a circular outer wall, and
the unit includes an inner ring separate from the wall and containing passages therethrough for conducting compressed air entering the housing in direction tangential to the turbine.

8. A method of reeling in a fishing line on a fishing pole, which includes the steps,
applying a fishing line to the fishing pole and,
applying an additional reel to the fishing pole, and
utilizing a source of air power separate from the fishing pole for actuating the additional reel and thereby reeling in the fishing line.

9. A fishing reel unit according to claim 5 wherein,
the housing includes a circular outer wall, and
the unit includes an inner ring separate from the wall and containing passages therethrough for conducting compressed air entering the housing in direction tangential to the turbine.
